(19) United States
(12) Patent Application Publication
(10) Pub. No.: US 2001/0011240 A1
(43) Pub. Date: Aug. 2, 2001

(54) BILL PROCESSING SYSTEM AND METHOD

(75) Inventors: WILLIAM KONRAD WARDIN, BARRINGTON, IL (US); RICHARD LOUIS HETKE, HINSDALE, IL (US); ROBERT ARNOLD JOHNSON JR, CARMEL, IN (US)

Correspondence Address: Law Office of Dale B. Halling, 24 S. Weber, Suite 311, Colorado Springs, CO, 80903, US

(73) Assignee: AMERITECH CORPORATION

(21) Appl. No.: 09/184,813

(22) Filed: Nov. 2, 1998

(51) Int. Cl. G06F 17/60

(52) U.S. Cl. 705/34; 705/40

(57) ABSTRACT

A bill processing system includes a bill data file (32) having a number of billing statements (34). A printing and mailing system (36) receives the bill data file (32) and determines a mailing date at a time of printing each of the billing statements (38). The printing and mailing system (36) determines a due date based on a predetermined formula. An output file (40) has an account number and the due date for each of the billing statements (38). A customer service system (42) receives the output file (40) and updates the due date associated with the account number.

### FIELD OF THE INVENTION

The present invention relates generally to the field of mailing systems and more particularly to a bill processing system and method.

1. Background of the Invention

Many corporations use outside vendors to print and mail their customer bills. These corporations are often required either contractually or by regulations to give their customers a set number of days to pay their bills from the date of mailing the bills. In the past the due dates for the bills were set so that there were some slippage days. As a result the due dates for the bills were often several days later than actually required. This resulted in a delay in receiving payments which caused the corporation needing significant additional capital. As a result, a system was developed that adjusts a bill's due date. The system uses a simple formula such as the due date is equal to the mailing date plus 30 days. Unfortunately, the information relating to the bill's adjusted due date is not available to customer service group of a corporation. This makes it impossible to determine if a customer is paying their bill by the adjusted due date. In addition, the system is limited to very simple formulas for determining the adjusted due date.

Thus there exists a need for a system that can adjust a bill's due date at the time of printing and update a customer service group's information.

### BRIEF DESCRIPTION OF THE DRAWINGS

FIG. 1 is a block diagram of a bill processing system in accordance with one embodiment of the invention;

FIG. 2 is a block diagram of a bill processing system in accordance with one embodiment of the invention;

FIGS. 3 & 4 are a flow chart of a method of operating a bill processing system in accordance with one embodiment of the invention; and

FIGS. 5 & 6 are a flow chart of a method of operating a bill processing system in accordance with one embodiment of the invention.

### DETAILED DESCRIPTION OF THE DRAWINGS

A bill processing system that can adjust due dates on the fly and update a customer service center includes a bill data file having a number of billing statements. A printing and mailing system receives the bill data file and determines a mailing date at the time of printing each of the billing statements. The due date for each of the billing statements is adjusted based on a formula. For instance the due date can be set to be 30 days from the mailing of the billing statement. In another embodiment, the due date can be set to be so many business days after mailing. This embodiment would adjust the due date based on national holidays and weekends. In yet another embodiment, the due date may be adjusted based upon an amount owed or payment history of the customer. Next, an output file having an account number and the due date for each of the billing statements is created. The customer service system receives the output file and updates the due date associated with the account numbers. This system is capable of adjusting a bill's due date and passing the adjusted due date information to the customer service system.

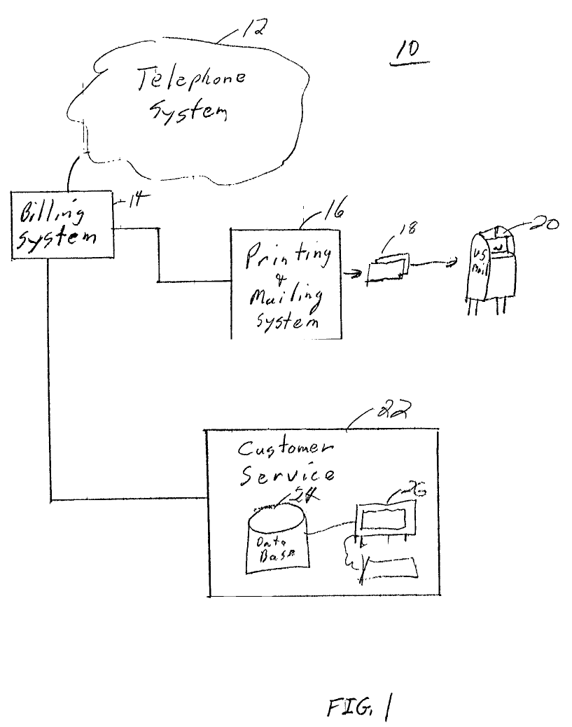

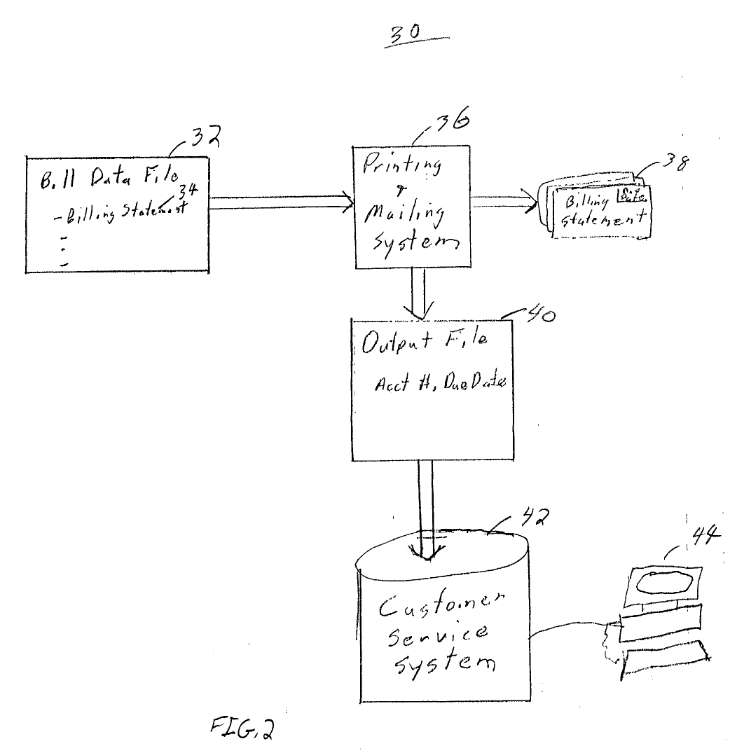

FIG. 1 is a block diagram of a bill processing system 10 in accordance with one embodiment of the invention. In this embodiment, a telephone company is the billing entity. The original billing information is generated by the telephone system 12. A billing system 14 organizes the billing information and creates a bill data file having a plurality of billing statements. A printing and mailing system 16 receives the bill data file. The printing and mailing system 16 determines a mailing date at a time of printing each of the plurality of billing statements. The printing system 16 adjusts the due date on the billing statements using a predetermined formula. The billing statement 18 is printed, stuffed into an envelope and mailed 20. The printing and mailing system 16 also creates an output file containing an account number and the due date for each of the plurality of billing statements. A customer service system 22 receives the output file and updates the due dates associated with the account numbers. This information is stored in a database 24 and can be accessed through a terminal 26.

FIG. 2 is a block diagram of a bill processing system 30 in accordance with one embodiment of the invention. An bill data file 32 contains a plurality of billing statements 34. The billing statements include: an account number, an amount owed and a billing address. In one embodiment, the billing statements include a target due date. In another embodiment, the billing statements include payment history information. In another embodiment, the billing statement contains a due date formula or due date formula indicator. A printing and mailing system 36 receives the bill data file 32 and determines a mailing date for each of the plurality of billing statements. A due date is determined. In one embodiment the due date is determined by adding a predefined number days (latency period) to the mailing date. In another embodiment, the due date is a predefined number of business days after the mailing date. Once the due date has been determined the billing statement 38 is printed. An output file 40 is created containing the account number (customer indicator) and the due date. The output file is used to update a customer service system database 42. A monitor 44 is used to access this information.

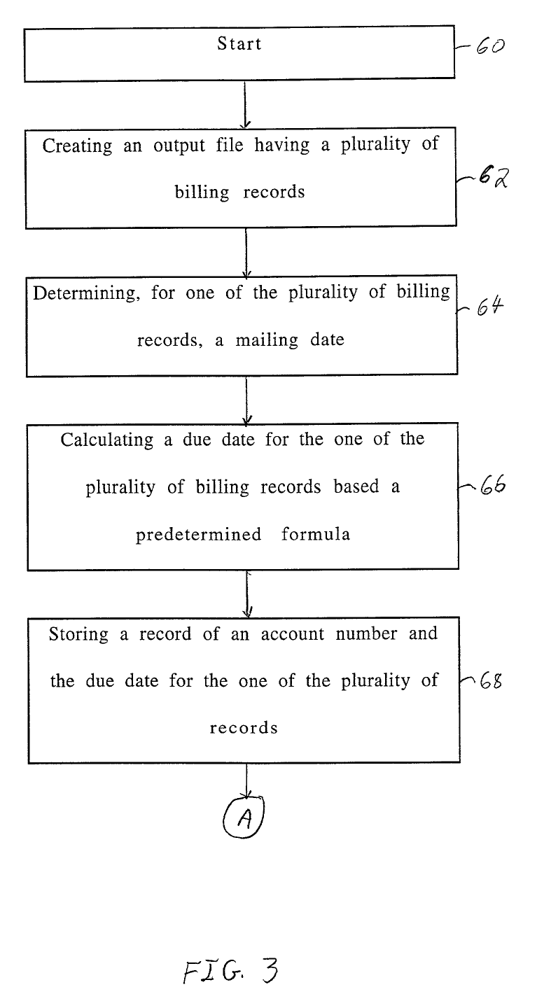

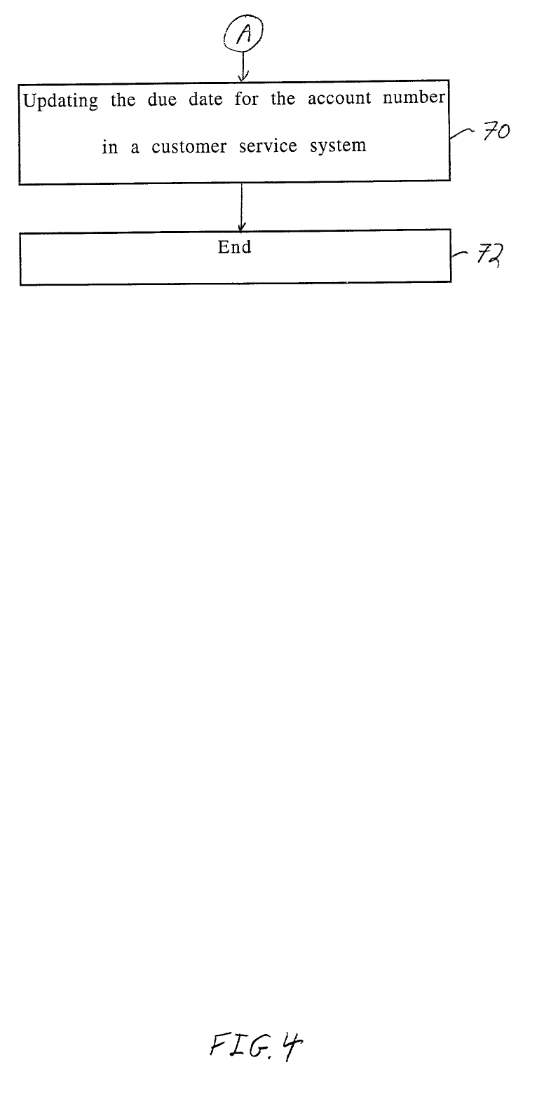

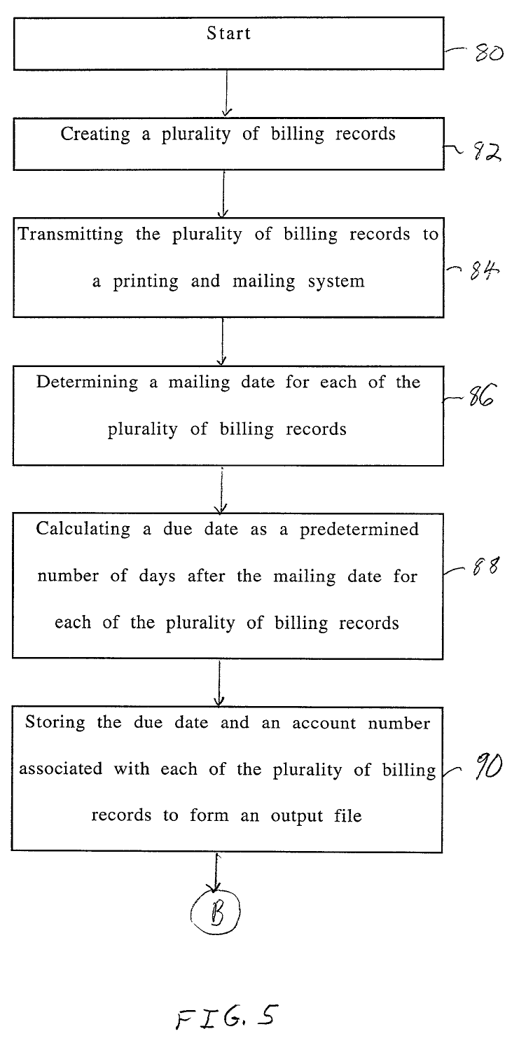

FIGS. 3 & 4 are a flow chart of a method of operating a bill processing system in accordance with one embodiment of the invention. The process starts, step 60, by creating an output file having a plurality of billing records at step 62. A mailing date is determined for one of the plurality of billing records at step 64. A due date is calculated for the one of the plurality of billing records based on a predetermined formula at step 66. A record of an account number and the due date for the one of the plurality of records is stored at step 68. At step 70, the due date for the account number is updated in a customer service system which ends the process at step 72.

In one embodiment, a payment is received for one of the plurality of billing records. A payment date of the received payment is stored. This payment date is compared to the due date. When the payment date is equal to or earlier than the due date, the account is determined to be current. When the payment date is later than the due date a late fee is determined. In another embodiment the system determines if a date (today's date) is later than the due date of one of the plurality of billing records. When the date is later than the due date for the one of the plurality of billing records an alert is generated in the customer service system.

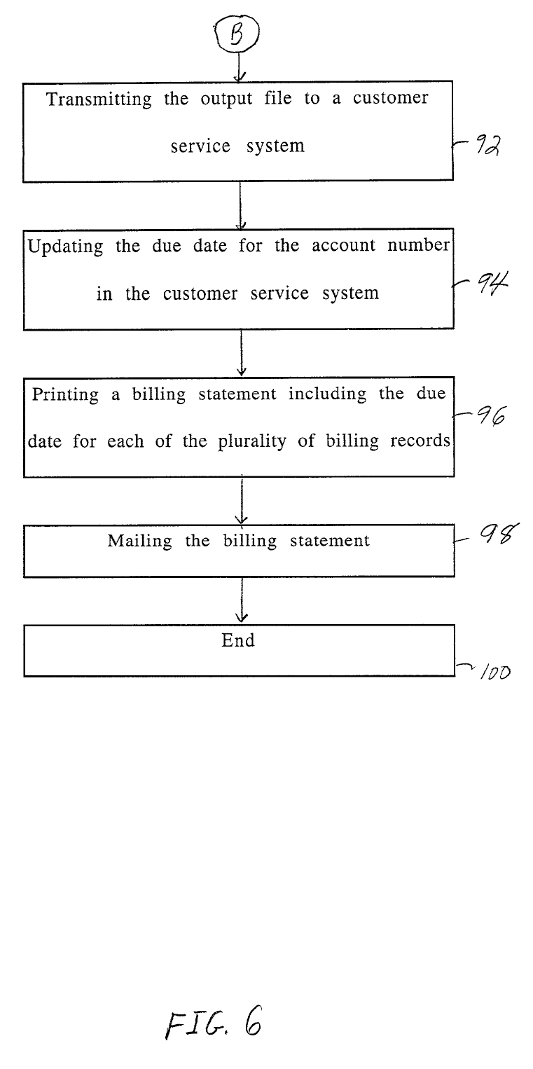

FIGS. 5 & 6 are a flow chart of a method of operating a bill processing system in accordance with one embodiment of the invention. The process starts, step 80, by creating a plurality of billing records at step 82. The plurality of billing records are transmitted to a printing and mailing system at step 84. A mailing date for each of the plurality of billing records is determined at step 86. A due date, for each of the plurality of billing records, is calculated as a predetermined number of days after the mailing date at step 88. The due date and an account number associated with each of the plurality of billing records is stored to form an output file at step 90. The output file is transmitted to a customer service system at step 92. The due date for the account number is updated in the customer service system at step 94. A billing statement including the due date for each of the plurality of billing records is printed at step 96. At step 98, the billing statement is mailed which ends the process at step 100.

In one embodiment a payment associated with the account is received. The received payment date is stored and compared with the due date. When the received payment date is earlier or equal to the due date, the account is determined to be current.

Using the invention due dates for bills can be based on almost any formula a customer desires. Once the due date for a bill has been determined it is passed along to a customer service center. This allows the customer service center to accurately monitor if payments are received on time. Using this invention a company can decrease the lag time between billing and receiving payment, thus reducing the working capital required by the company.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A bill processing system comprising:
a bill data file having a plurality of billing statements;
a printing and mailing system receiving the bill data file, the printing and mailing system determining a mailing date at a time of printing each of the plurality of billing statements and determining a due date based on a predetermined formula;
an output file having an account number and the due date for each of the plurality of billing statements; and
a customer service system receiving the output file and updating the due date associated with the account number.

2. The bill processing system of claim 1, wherein the plurality billing statements include a target due date.

3. The bill processing system of claim 1, wherein the predetermined formula determines the due date by adding a predefined number of days to the mailing date.

4. A method of operating a bill processing system comprising the steps of:
(a) creating an output file having a plurality of billing records;
(b) determining, for one of the plurality of billing records, a mailing date;
(c) calculating a due date for the one of the plurality of billing records based on a predetermined formula;
(d) storing a record of an account number and the due date for the one of the plurality of records; and
(e) updating the due date for the account number in a customer service system.

5. The method of claim 4, wherein step (c) further includes the step of:
(c1) printing a billing statement having the due date.

6. The method of claim 5, further including the step of:
(c2) mailing the billing statement.

7. The method of claim 4, further including the steps of:
(f) receiving a payment for one of the plurality of billing records;
(g) storing a payment date received for the payment;
(h) comparing the payment date to the due date;
(i) when the payment date is equal to or earlier than the due date, the account is determined to be current.

8. The method of claim 7, further including the step of:
(j) when the payment date is later than the due date, determining a late fee.

9. The method of claim 4, further including the steps of:
(f) determining if a date is later than the due date of one of the plurality of billing records;
(g) when the date is later than the due date for the one of the plurality of billing records, generating an alert in the customer service system.

10. The method of claim 4, wherein step (c) further includes the steps of:
(c1) determining a payment history;
(c2) looking up a latency period based on the payment history;
(c3) determining the due date as the mailing date plus the latency period.

11. The method of claim 4, wherein step (c) further includes the steps of:
(c1) determining a due date a predetermined number business days from the mailing date.

12. A method of operating a billing system comprising the steps of:
(a) creating a plurality of billing records;
(b) transmitting the plurality of billing records to a printing and mailing system;
(c) determining a mailing date for each of the plurality of billing records;
(d) calculating a due date as a predetermined number of days after the mailing date for each of the plurality of billing records;
(e) storing the due date and an account number associated with each of the plurality of billing records to form an output file;
(f) transmitting the output file to a customer service system;
(g) updating the due date for the account number in the customer service system;
(h) printing a billing statement including the due date for each of the plurality of billing records; and
(i) mailing the billing statement.

13. The method of claim 12, further including the step of:
(j) receiving a payment associated with the account number;
(k) storing a received payment date;
(l) comparing the received payment date to the due date;
(m) when the received payment date is earlier or equal to the due date, updating an account record as current.

14. A computer-readable storage medium containing computer-readable instructions that when executed by a computer performs the steps of:
(a) creating an output file having a plurality of billing records;
(b) determining, for one of the plurality of billing records, a mailing date;
(c) calculating a due date for the one of the plurality of billing records based on the mailing date;
(d) storing a record of an account number and the due date for the one of the plurality of records; and
(e) updating the due date for the account number in a customer service system.

15. The computer-readable storage medium of claim 14, wherein step (c) further includes the step of:
(c1) printing a billing statement having the due date.

16. The computer-readable storage medium of claim 15, further including the step of:
(c2) mailing the billing statement.

17. The computer-readable storage medium of claim 14, further including the steps of:
(f) receiving a payment for one of the plurality of billing records;
(g) storing a payment date received for the payment;
(h) comparing the payment date to the due date;
(i) when the payment date is equal to or earlier than the due date, the account is determined to be current.

18. The computer-readable storage medium of claim 17, further including the step of:
(j) when the payment date is later than the due date, determining a late fee.

19. The computer-readable storage medium of claim 14 further including the steps of:
(f) determining if a date is later than the due date of one of the plurality of billing records;
(g) when the date is later than the due date for the one of the plurality of billing records, generating an alert in the customer service system.
